(19) United States
(12) Patent Application Publication
(10) Pub. No.: US 2003/0078036 A1
(43) Pub. Date: Apr. 24, 2003

(54) Device and method for automatically installing software by wireless identification

(76) Inventors: Yuan-Jung Chang, Hsinchuang City (TW); Chun-Wei Kao, Chungho City (TW); Chia-Ming Chung, Sanchung City (TW); Shyhjir Ferng, Hsintien City (TW); Chien-Kun Liao, Panchiao City (TW); Bee Yeong Khoo, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/981,724

(22) Filed: Oct. 19, 2001

(51) Int. Cl. H04M 3/00

(52) U.S. Cl. 455/419; 455/41; 455/420

(57) ABSTRACT

A method for automatically installing software by the wireless identification is proposed for a master device and a remote wireless device. The remote wireless device is stored with at least one wireless communication protocol, driver, and application program. The remote wireless device seriatim checks for one available wireless communication protocol for the master device and the remote wireless device, and then the master device sends internal system resource and environment parameters of itself to the remote wireless device for setting control commands and parameters acceptable for the master device and the remote wireless device both. The remote wireless device sends the driver or the application program to the master device for being installed in the master device.

### FIELD OF THE INVENTION

The present invention relates to a device and a method for automatically installing software by wireless identification, especially to a device and a method for automatically installing software by storing at least one wireless communication protocol, driver and application program in a remote wireless device to automatically detect the communication protocol for a master device, communicate with the master device via the communication protocol, and install the driver and the application program.

### BACKGROUND OF THE INVENTION

The conventional computers and the peripherals thereof generally need to install drivers and set up some configurations before communicating with each other. For example, a computer should be installed with a correct driver and application software before communicating with the printer successfully. There is one technique so-called Plug-and-Play such as a USB interface. A personal computer uses the USB interface to connect with other devices, but the drivers need to be installed inside first; otherwise, the computer will ask user to install needed driver when a new or an unsupported device is connected. Hence, if a new device with drivers inside is connected with the computer, drivers will be transmitted to the computer and installed automatically without users' operations. In this method, we can really call it Plug-and-Play. If two devices need to communicate with each other in a wireless manner, the way for communication, like IrDA, adopted by each device should be set up and then a corresponding driver for IrDA is installed on both devices. The above procedure should be carried out if the communication between a PDA and a personal computer is going to set up; however, those steps are relatively cumbersome for users not familiar with computer or PDA operations and should be handled by developers. For example, IrDA drivers are stored in the PDA with IrDA transmission function at first and then installed to the computer if the PDA with IrDA transmission function is going to communicate with the computer. It is that IrDA drivers will automatically be installed to the computer while the PDA is connected with the computer, leading to setting up communication between the PDA and the computer without being provided any driver by users and avoiding the weakness that related drivers are lost. It is the object of the present invention to provide a device and a method for automatically installing software by wireless identification and transmission. In other words, a wireless device stores at least one driver program, at least one application program and corresponding configuration settings at first. After the wireless device is turned on, the stored driver program, application program and corresponding configuration settings are sent to a master device via existing available communication protocol. Thus, there is no need to do extra software installation or configuration settings.

The U.S. Pat. No. 6,195,712 discloses a dynamic method for detecting computer peripherals by a wireless transmission technique, wherein the computer peripherals have no physical connection to a computer. This prior art is that the computer actively detects whether its peripherals exist or not and controls them thereafter. However, available communication protocols and control commands have to be stored in the computer in advance.

The U.S. Pat. No. 6,108,727 discloses a wireless device receives compressed files from a remote master device for installing these compressed files. The remote master device can be connected to at least one such wireless device in a wireless communication manner. However, the wirelessly transmitted files are compressed execution files like *.exe and *.com files. These execution files can be automatically compressed before the transmission of these files and decompressed after being transmitted to the wireless device. Of course, the above procedure is performed by predefining the communication protocols and control commands in advance. The U.S. Pat. No. 6,141,683 discloses a method for remotely updating computer software. This method is suitable for updating software in subway stations, spaceships, electronic postage meters or medical monitors for patients by a remote console. However, this method involves a specific wireless transfer center to transfer information and update software. Thus, the handshaking in advance for both ends are necessary in this granted patent. The U.S. Pat. No. 5,896,566 discloses a wireless updating method by a wireless communication system such as a cellular phone base station to update software of wireless communication units like cellular phones or portable computers. The wireless updating method employs a battery charger and a software downloader to download programs from the wireless communication system. However, the handshaking of communication protocols and control commands have to be performed in advance also.

It is obvious that the cited patents all require software installation and setting configurations in advance if communications between two ends are to be established even they are also in the same wireless communication manner. But the present invention does not need users to provide or install software and configuration settings.

### SUMMARY OF THE INVENTION

It is an object of the present invention to provide a device and a method for automatically installing software by wireless identification, wherein at least one wireless communication protocol is stored in a remote wireless device to automatically detect which communication protocol is available for a master device the remote wireless device in some orders from the stored wireless communication protocols and there is no need to set up any communication protocol in advance while communicating with the master device.

It is another object of the present invention to provide a device and a method for automatically installing software by wireless identification, wherein at least one driver program and application program are stored in a remote wireless device. The remote wireless device can send the driver program and application program to a master device while linked with the master device, and users need not to install any other driver program or application program.

It is another object of the present invention to provide a device and a method for automatically installing software by the wireless identification, wherein a remote wireless device can automatically detect the system resource of a master device including its hardware architecture, its system environment, its computation capability and its control capability for the purpose of communicating successfully with the master device.

In accordance with the claimed invention, a method for automatically installing software by the wireless identification is proposed for a master device and a remote wireless device. At least one wireless communication protocol, driver program, and application program are stored in the database of the remote wireless device initially. The remote wireless device seriatim checks one acceptable wireless communication protocol for the master device and itself, then the master device sends its internal system resource and environment parameters to the remote wireless device. As this result, commands and parameters acceptable for both the master device and the remote wireless device are established. The remote wireless device sends the driver program or the application program to the master device for installing the driver program and the application program to the master device. In another aspect of the present invention, a device for automatically installing software by the wireless identification and transmission is proposed. The device for automatically installing software includes a master device with a wireless transmission module and transmitting data according to a wireless communication protocol, a remote wireless device with another wireless transmission module to communicate with the master device through the air, a database set in the remote wireless device for storing at least one wireless communication protocol, driver program and application program, as well as functional information of the master device, installing information of the application program, personalized control mode and preference information data, and a central processing unit used to detect the communication protocol with the master device, install the driver program, transmit control commands, install the application program and fetch parameters from the master device.

The various objects and advantages of the present invention will be more readily understood from the following detailed description when read in conjunction with the appended drawing.

### BRIEF DESCRIPTION OF DRAWINGS

FIG. 1 shows a block diagram of a device for automatically installing software through the wireless identification according to the present invention;

FIG. 2 shows an operation flowchart of a protocol detection program according to the present invention;

FIG. 3 shows an operation flowchart of a configuration inquiry/detection program according to the present invention;

FIG. 4 shows an operation flowchart of a software installation program according to the present invention;

FIG. 5 shows an operation flowchart of a preference management program according to the present invention;

FIG. 6 shows an operation flowchart of a database transferring program according to the present invention;

FIGS. 7 to 11 is a preferred embodiment of the present invention.

### DETAILED DESCRIPTION OF THE INVENTION

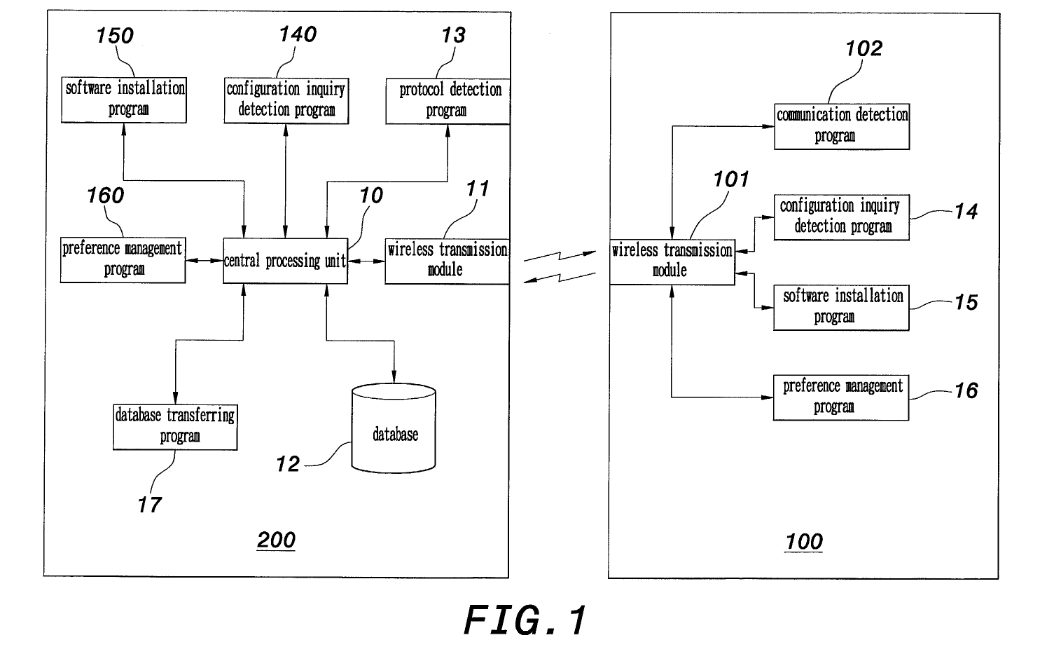

Please refer to FIG. 1 of a block diagram of a device for automatically installing software through the wireless identification according to the present invention. The inventive device includes a master device 100 having a wireless transmission module 101, a communication detection program electrically connected to the wireless transmission module 101, a configuration inquiry/detection program 14 electrically connected to the wireless transmission module 101, a software installation program 15 electrically connected to the wireless transmission module 101, and a preference management program 16 electrically connected to the wireless transmission module 101 also. A remote wireless device 200 includes a central processing unit 10, a wireless transmission module 11 connected to the central processing unit 10 electrically, a database 12 electrically connected to the central processing unit 10, a protocol detection program 13 electrically connected to the central processing unit 10, a configuration inquiry/detection program 140 electrically connected to the central processing unit 10, a software installation program 150 electrically connected to the central processing unit 10, a preference management program 160 electrically connected to the central processing unit 10, and a database transferring program 17 electrically connected to the central processing unit 10 also.

The master device 100 communicates with a remote wireless device 200 through the air with its wireless transmission module 101 and 11 respectively, which can base on an IrDA, a Bluetooth, a 802.11x, a RF, a Hiper LAN, an IR or a laser interface. The master device 100 can be an information device with wireless communication function such as a desktop computer, a mainframe computer, a server, or a portable computer; an electrical appliance such as a television, an audio set, an air conditioner or a refrigerator, or a portable compact information device such as a handheld computer, a PDA or a cellular phone.

The remote wireless device 200 can be a computer peripheral with wireless communication function such as a printer, a monitor, a digital pad, a mouse, a scanner, a modem, a network terminal, a compact electronic information device such as a handheld computer, a PDA or a cellular phone. The central processing unit 10 is used to control the remote wireless device 200 and to detect the communication protocol of the master device 100. Moreover, the central processing unit 10 is to install the acceptable driver to the master device 200 and remote wireless device 100, transmit control commands, install application programs and fetch parameters of the master device 100. The database 12 stores at least one wireless communication protocol, at least one driver and at least one application program. The database 12 can be used to store functional information, installing information of the application program, personalized control mode and preference information data of the master device 100. The database 12 is a storage media such as an EEPROM, a flash memory, a floppy disk, a hard disk or a CD/DVD.

The present invention provides an automatic identification and communication method between the master device 100 and the remote wireless device 200, wherein the database 12 of the remote wireless device 200 stores at least one wireless communication protocol such as an IrDA or a Bluetooth, a 802.11x, a RF, a Hiper LAN, an IR, or a laser communication protocol. The remote wireless device 200 uses the protocol detection program 13 to seriatim check existing communication protocols for the master device 100 until establishing the communication with the master device 100. The master device 100 uses the communication detection program 102 to detect continually whether the remote wireless device 200 tries to communicate with the master device 100. Once the master device 100 detects a signal from the remote wireless device 200, the communication detection program 102 generates an interrupt to the central processing unit 10 of the master device 100 for receiving data from the remote wireless device 200. To summarize, the communication between the master device 100 and the remote wireless device 200 is established by the protocol detection program 13 and the communication detection program 102.

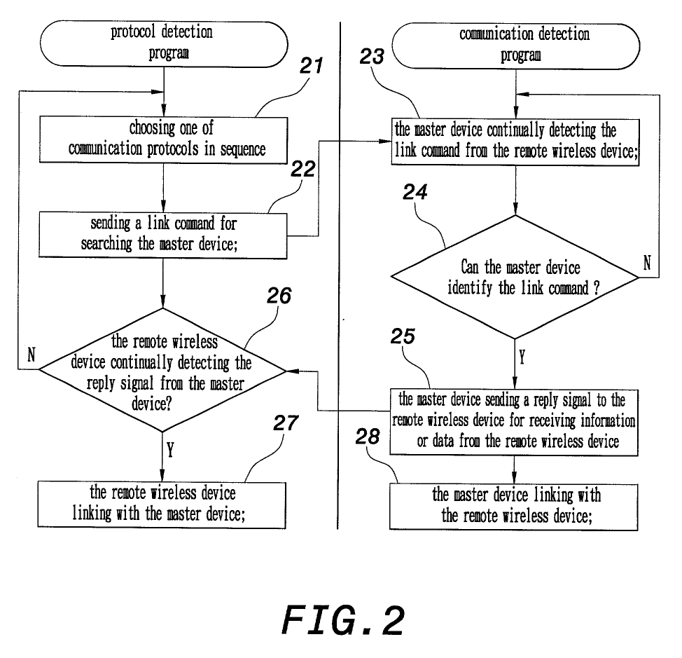

Please refer to FIG. 2 of an operation flowchart of the protocol detection program 13 in conjunction with FIG. 1. The protocol detection program 13 in FIG. 1 includes following steps:

step 21: the remote wireless device 200 choosing one of communication protocols such as IrDA stored in itself in sequence;

step 22: the remote wireless device 200 sending a link command for searching the master device 100 according to the chosen communication protocol;

step 23: the master device 100 continually detecting the link command from the remote wireless device 200;

step 24: if the master device 100 identifying the link command, execute step 25, else back to step 23;

step 25: the master device 100 sending a reply signal to the remote wireless device 200 for being ready to receive information or data from the remote wireless device 200;

step 26: the remote wireless device 200 continually detecting the reply signal from the master device 100, if no, back to step 21 for choosing another communication protocol and then communicating with the master device 200 again, if yes, go to step 27;

step 27: the remote wireless device 200 completing the communication with the master device 100; and

step 28: the master device 100 completing the communication with the remote wireless device 200, and an interrupt being sent to the master device 100 for being ready to receive information or data from the remote wireless device 200.

After the remote wireless device 200 is linked with the master device 100, the remote wireless device 200 executes the configuration inquiry/detection program 140 and sends the configuration inquiry/detection program 140 to the master device 100 for detecting the configuration settings of the master device 100 in cooperation with the configuration inquiry/detection program 14. The configuration inquiry/detection program 140 sends the required configuration settings and the environment parameters of the remote wireless device 200 to the master device 100 for communicating with each other under acceptable configuration settings and environment parameters for the remote wireless device 200 and the master device 200 both. The configuration settings of the master device 100 are stored in the database 12 of the remote wireless device 200 and are reused by the remote wireless device 200 unless the configuration settings of the master device 100 are changed. The main purpose of the configuration inquiry/detection program 14 is to detect the system resource of the master device 100, including the hardware architecture, the system environment, the computation capability and the control capability, which are for cooperating with the remote wireless device 200 to establish acceptable commands and parameters for two parties.

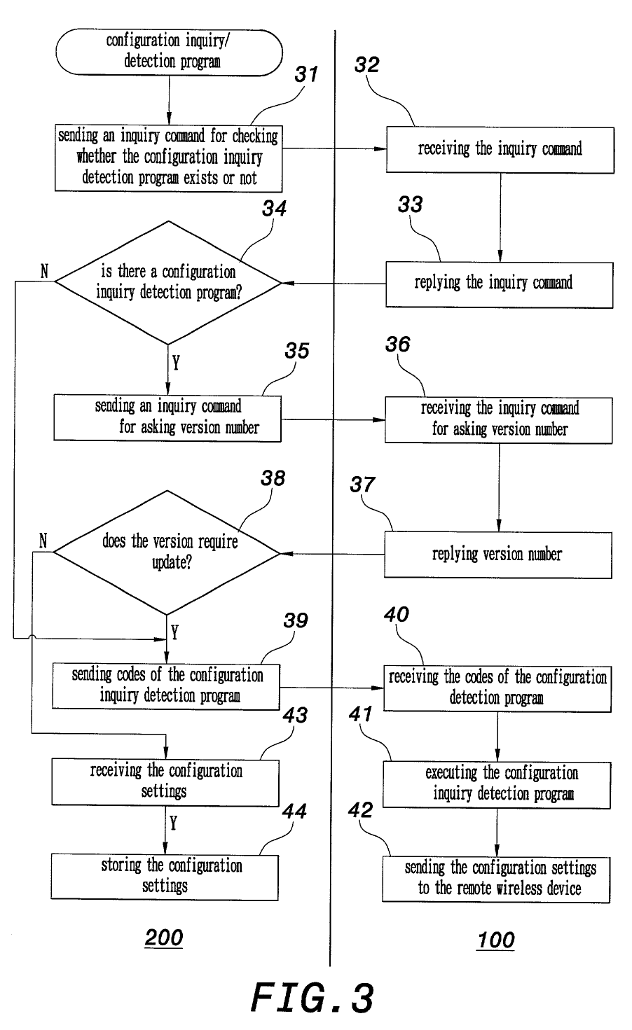

Please refer to FIG. 3 of an operation flowchart of the configuration inquiry/detection program 140 in conjunction with FIG. 1. The configuration inquiry/detect program 140 includes following steps:

step 31: the remote wireless device 200 sending an inquiry command to check whether the master device 100 has the configuration inquiry/detection program 14 or not;

step 32: the master device 100 receiving the inquiry command from the remote wireless device 200;

step 33: the master device 100 replying if the master device 100 has the configuration inquiry/detect program 14 or not to the remote wireless device 200;

step 34: the remote wireless device 200 determining whether the master device 100 already has the configuration inquiry/detection program 14, if yes, go to step 35, if not, go to step 39;

step 35: the remote wireless device 200 sending an inquiry command for asking version number of the configuration inquiry/detection program 14;

step 36: the master device 100 receiving the inquiry command for asking version number;

step 37: the master device 100 replying the version number to the remote wireless device 200;

step 38: the remote wireless device 200 determining whether the configuration inquiry/detection program 14 requires update or not, if yes, go to step 39, if not, go to step 43;

step 39: the remote wireless device 200 sending codes of the configuration inquiry/detection program 14 to the master device 100;

step 40: the master device 100 receiving the codes of the configuration inquiry/detection program 14 from the remote wireless device 200;

step 41: the master device 100 executing the configuration inquiry/detection program 14;

step 42: the configuration detection program 14 sending the configuration settings of the master device 100 to the remote wireless device 200;

step 43: the remote wireless device 200 receiving the configuration settings of the master device 100; and

step 44: the remote wireless device 200 storing the configuration settings of the master device 100 to establish the configuration settings and the environment parameters acceptable for both parties.

After establishing the acceptable configuration settings and environment parameters for the remote wireless device 200 and the master device 100, the driver and the application programs stored in the remote wireless device 200 can be automatically transmitted to the master device 100 for being installed and executed. After the executing the driver and the application programs, the master device 100 stores the version number of the driver and the application programs. Therefore, the driver and the application programs will not be retransmitted to the master device 100 next time unless the driver or the application programs are updated.

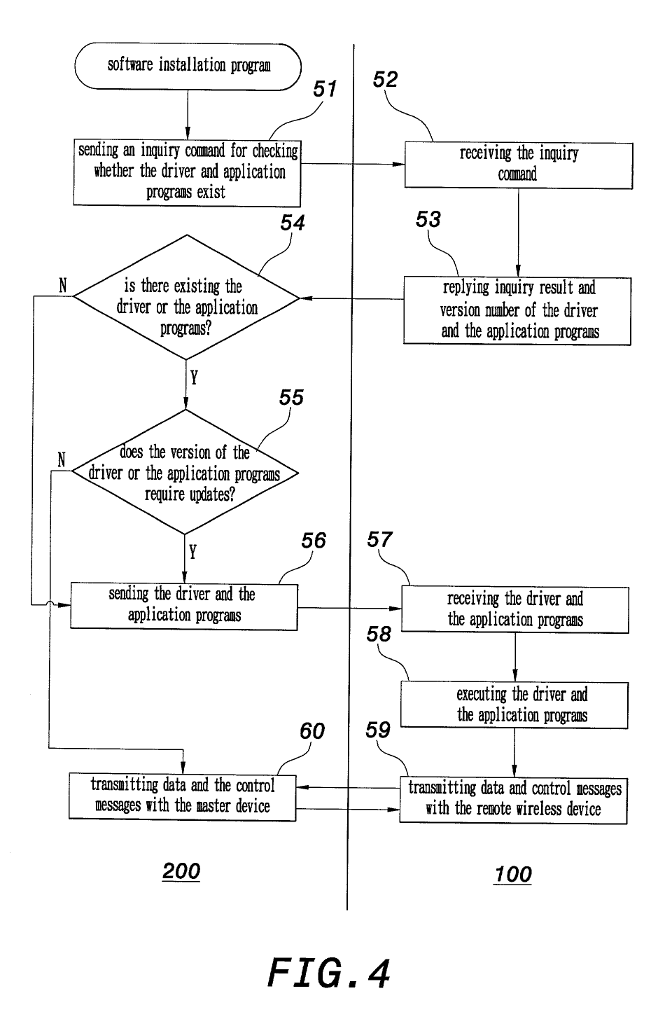

Please refer to FIG. 4 of an operation flowchart of the software installation program 150, whose purpose is to install or execute the driver or the application programs, in conjunction with FIG. 1. The software installation program includes following steps:

step 51: the remote wireless device 200 sending an inquiry command for checking whether the driver or the application programs are installed in the master device 100 and the version number of the driver or the application programs are stored in the mainframe device 100 or not;

step 52: the master device 100 receiving the inquiry command from the remote wireless device 200;

step 53: the master device 100 replying if the driver or the application programs are installed in the master device 100 or not to the remote wireless device 200;

step 54: the remote wireless device 200 determining whether the master device 100 is installed with the driver or the application programs therein, if true, go to step 55, if not, got to step 56;

step 55: the remote wireless device 200 determining whether the version number of the driver and the application programs require updates or not, if true, go to step 56, if not, go to step 60;

step 56: the remote wireless device 200 sending codes of the driver and the application programs to the master device 100;

step 57: the master device 100 receiving the codes of the driver and the application programs from the remote wireless device 200;

step 58: the master device 100 executing the driver and the application programs;

step 59: the master device 100 exchanging data and control messages with the remote wireless device 200; and

step 60: the remote wireless device 200 exchanging data and control messages with the master device 100.

The software installation program 150 initially detects whether the master device 100 is installed with required driver or the application programs or not and takes the configuration settings obtained by the configuration inquiry/detection program 14 into consideration before choosing the driver and the application programs suitable for the master device 100. For example, if the operation system of the master device 100 is Windows 98, the software installation program 150 sends the driver or the application programs with version of Windows 98 version from the database 12 to the master device 100 and then the driver or the application programs are executed. If the operation system of the master device 100 is Palm OS 3.5, the software installation program 150 sends the driver or the application programs with version of Palm OS 3.5 from the database 12 to the master device 100.

In the present invention, the operation preference and control mode of a user are recorded for reference. The data of operation preference and control model are stored in the master device 100 and the database 12 of the remote wireless device 200. When another new master device 100 is to be connected to the remote wireless device 200, or a new remote wireless device 200 is to be connected to the master device 100, the data of operation preference and control mode are used for establishing a suitable operating environment regarding to the user whose operation preference and control mode are stored before. In the present invention, a preference management program 16 and 160 are used for collecting and storing the operation preferences and control modes.

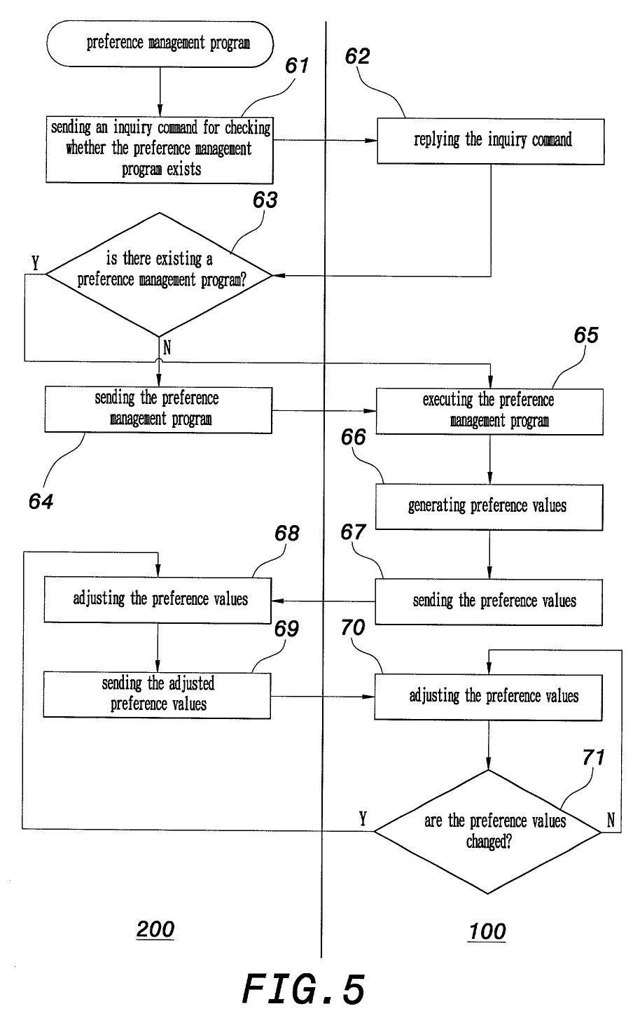

Please refer to FIG. 1 in conjunction with FIG. 5 of an operation flowchart of the preference management program 160, which has following steps:

step 61: the remote wireless device 200 sending an inquiry command for checking whether the master device 100 has the preference management program 16 or not;

step 62: the master device 100 replying if the master device 100 is installed with the preference management program 16;

step 63: the remote wireless device 200 determining whether the master device 100 already has the preference manage program 16, if true, go to step 65, if not, go to step 64;

step 64: the remote wireless device 200 sending codes of the preference management program 160 to the master device 100;

step 65: the master device 100 executing the preference management program 16;

step 66: a set of preference values being generated according to the operation preference of the user while operating the master device 100 and the remote wireless device 200;

step 67: the master device 100 sending the preference values to the remote wireless device 200;

step 68: the remote wireless device 200 adjusting the preference values according to the operation preferences continually and storing the adjusted preference values;

step 69: the remote wireless device 200 sending the adjusted preference values to the master device 100;

step 70: the master device 100 storing the preference values and adjusting the preference values according to the operation preferences of the user continually;

step 71: the master device 100 determining whether the preference values are changed or not; if true, go to step 68, if not, go to step 70;

In the present invention, contents of the database 12 of the remote wireless device 200 can be transferred to the master device 100 such that the data of the master device 100 can be simultaneously updated with the data of the remote wireless device 200. For example, the remote wireless device 200 is a PDA and the master device 100 is a personal computer. To edit the address book of the PDA 200 by the personal computer 100, the address book of the PDA 200 is transferred to the PC 100 and edited by the personal computer 100. Afterward, the modified address book is stored back to the PDA 200. In some situations, the transfer of the database 12 is temporary. Therefore, the database 12 is transferred from the remote wireless device 200 to the master device 100 once they are connected and the database is removed from the master device 100 after the remote wireless device 200 and the master device 100 is not connected with each other. This preserves privacy of the user when many users are authorized to have access to the same master device 100.

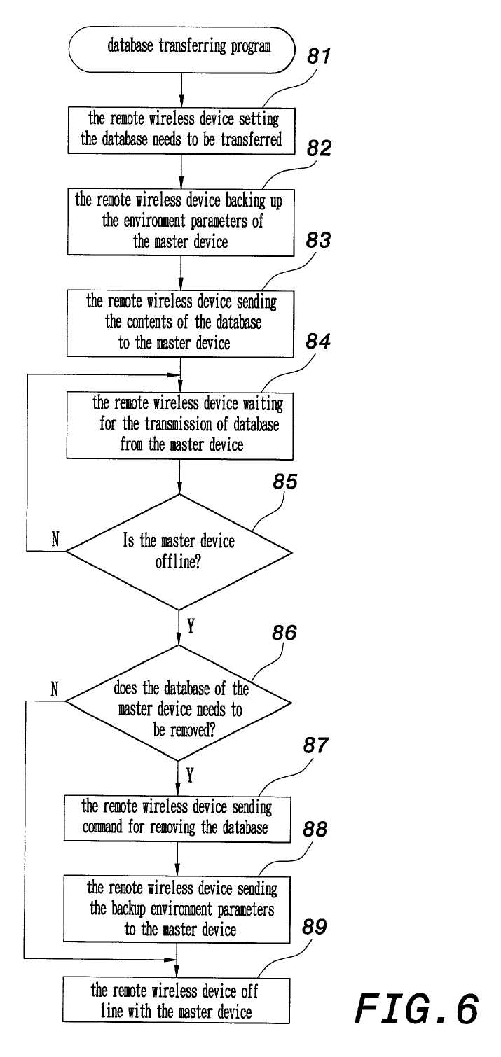

Please refer to FIG. 1 in conjunction with FIG. 6 of an operation flowchart of the database transferring program 170, which has following steps:

step 81: the user setting that the database 12 of the remote wireless device 200 needs to be transferred;

step 82: the remote wireless device 200 backing up the environment parameters of the master device 100;

step 83: the remote wireless device 200 sending contents of the database 12 to the master device 100;

step 84: the remote wireless device 200 waiting for the retransmission of the contents of the database 12 from the master device 100;

step 85: the remote wireless device 200 checking whether the master device 100 requires an off-line or not, if true, go to step 86, if not, go to step 84;

step 86: the remote wireless device 200 requesting the user that the contents of the database 12 and the environment parameters stored in the master device 100 need to be removed or not, if yes, go to step 87, if not, go to step 89;

step 87: the remote wireless device 200 sending a command for removing the contents of the database 12 stored in the master device 100;

step 88: the remote wireless device 200 sending the backup environment parameters to the master device 100 and the master device 100 restoring the previous environment parameters;

step 89: the remote wireless device 200 being off-line with the master device 100.

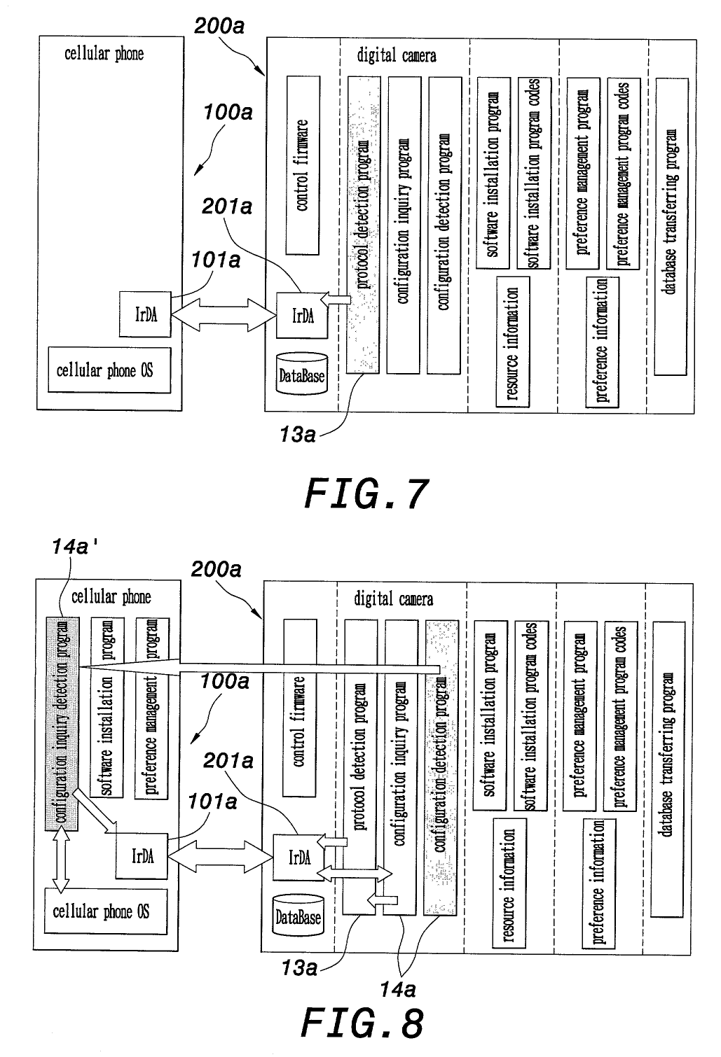

Please refer from FIG. 7 to FIG. 11. Hereinafter a preferred embodiment of the present invention is stated for demonstrating the present invention in detail. The master device 100 is a cellular phone 100a and the remote wireless device 200 is a digital camera 200a. As shown in FIG. 7, the digital camera 200a stores many user preferences and command settings after being used for several times. The user can use the IrDA wireless transmission module 201a of the digital camera 200a to link with the IrDA wireless transmission module 101a of the cellular phone 100a. At first, the protocol detection program 13a of the digital camera 200a sends an inquiry command to the cellular phone 100a to identify the protocol of the cellular phone 100a, and then to establish a wireless link with the cellular phone 100a.

After the digital camera 200a is linked with the cellular phone 100a, the configuration inquiry/detection program 14a of the digital camera 200a automatically loads the configuration inquiry/detection program 14a′ to the cellular phone 100a in case that the cellular phone 100a does not have corresponding counterpart. The configuration detection program 14a′ collects the configuration settings of the cellular phone 100a and sends the configuration settings of the cellular phone 100a to the digital camera 200a. It should be noted that the digital camera 200a is successfully linked with the cellular phone 100a at this point.

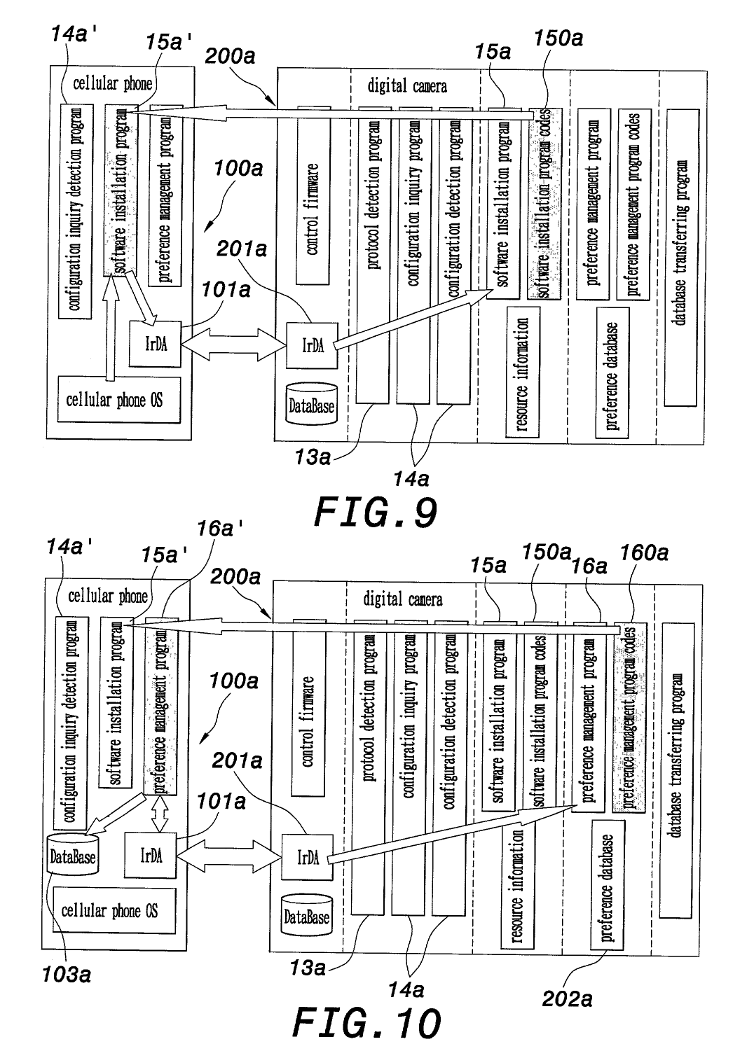

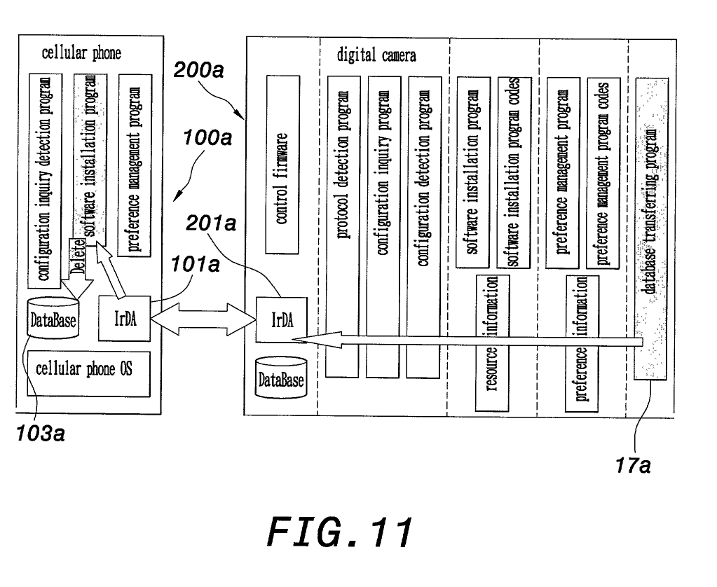

Please refer to FIG. 9 and FIG. 10. The digital camera 200a receives the configuration settings of the cellular phone 100a from the cellular phone 100a and ensures the successful link with the cellular phone 100a. Afterward, the digital camera 200a sends an inquiry command to recognize if the cellular phone 100a has been installed with the software installation program 15a or not. The digital camera 200a automatically loads the software installation program 15a to the cellular phone 100a as the software installation program 15a′ in case that the cellular phone 100a does not have any software installation program. After the cellular phone 100a is installed with a suitable driver program by the software installation program 15a′, the cellular phone 100a has the duplex communication with the digital camera 200a. Therefore, the user can use the wireless transmission module 101a of the cellular phone 100a to control the digital camera 200a remotely for taking, showing and erasing photos. If the software installation program 15a′ is not existed in the cellular phone 100a while the cellular phone 100a linked with the digital camera 200a, codes of the software installation program 150a will be transmitted to the cellular phone 100a for installing and executing the software installation program 15a′.

Please refer to FIG. 10, when the user employs the cellular phone 100a to remotely control the digital camera 200a, the preference management program 16a is executed in the digital camera 200a and sends the preference data of the user to the cellular phone 100a. Therefore, the user can operate the cellular phone 100a to remotely control the digital camera 200a with his or her preferred settings. For example, the user has established preferred settings in the digital camera 200a such as the optimal diaphragm, the focus and resolution setting, and a control mode. Thereafter a preference database 103a for storing the aforementioned preference data is established in the cellular phone 100a. As shown as in FIG. 10, the digital camera 200a continually adjusts stored user's preferred settings while being operated by the user again and again. These preferred settings are stored in a preference database 202a of the digital camera 200a. Therefore, the cellular phone 100a and the digital still camera 200a can track and record the latest preference data of user. If the preference management program 16a′ is not installed in the cellular 100a while the cellular phone 100a is linked with the digital camera 200a, codes of the preference management program 160a stored in the digital camera 200a will be transmitted to the cellular phone 100a for installing and executing the preference management program 16a′.

Please refer to FIG. 11. If another user uses the cellular phone 100a or the digital camera 200a, he can erase the previous preference database 103a by the wireless transmission module 201a of the digital camera 200a or by the cellular phone 100a itself. If cellular phone 100a has completed the above procedure and the user tries to connect a new digital camera 200a with the cellular phone 100a, there is no need to set up the new digital camera 200a again because what are required in setting up have been stored in the cellular phone 100a before and can be transmitted to the digital camera 200a for his or her purpose. To sum up, the present invention provides an device and a method for automatically installing software by the wireless identification and transmission. The invention can provides following advantages to a master device and a remote wireless device without complicated settings.

1. Automatic detection of wireless communication protocols.

2. Automatic detection of configuration settings in the master device.

3. Automatic loading and installing communication software.

4. Automatic recording and updating preference data.

5. Intelligently transferring preference data.

The features of the present invention can be applied to all electrical appliances and brings much more convenience to users.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intend to be embraced within the scope of the invention as defined in the appended claims.

I claim:

1. A method for automatically installing software by wireless identifications and transmissions, enabling at least one remote wireless device transmitting software and control commands to a master device, for exchanging information, controlling remotely, and installing and configuring the software with the remote wireless device, the method comprising following steps of:
storing at least one wireless communication protocol in the remote wireless device;
choosing one of the wireless communication protocols in sequence for communicating with the master device;
the master device sending configuration settings thereof, including internal system resource and environment parameters, to the remote wireless device for establishing the configuration settings and the environment parameters acceptable for both of the master device and the remote wireless device;
storing at least one driver or application program in the remote wireless device for transmitting the driver or the application program to the master device, and the driver or the application program being installed and executed in the master device.

2. The method of claim 1 further comprising the step that the remote wireless device stores the internal system resource and the environment parameters of the master device therein while communicating with each other for the first time and asks the master device not to retransmit the internal system resource and the environmental parameters unless the internal system resource and the environment parameters are changed.

3. The method of claim 1 further comprising the step that the master device stores version number of the driver and the application program after installing and executing the driver and the application program and reinstalls the driver or the application program if the driver or the application program updates its version number.

4. The method of claim 1, wherein the wireless communication protocol comprises an IrDA, a Bluetooth, a 802.11x, a RF, a Hiper LAN, an IR, or a laser communication protocol.

5. The method of claim 1 wherein the communication protocol is established by a protocol detection program, which comprises:
(a) the remote wireless device choosing one of the communication protocols;
(b) the remote wireless device sending a link command for searching the master device according to the communication protocol;
(c) the master device detecting the link command from the remote wireless device;
(d) if the master device identifying the link command, execute step (e), else back to step (c);
(e) the master device sending a reply signal to the remote wireless device for receiving information from the remote wireless device;
(f) the remote wireless device continually detecting the reply signal from the master device, if no, back to the step (a) for choosing another communication protocol and then communicating with the master device again, if yes, back to the step (g);
(g) the remote wireless device completing the communication with the master device; and
(h) the master device completing the communication with the remote wireless device.

6. The method of claim 1, wherein the master device sends configuration settings thereof to the remote wireless device by a configuration inquiry/detection program, which comprises:
(a) the remote wireless device sending an inquiry command for checking whether the master device comprises the configuration inquiry/detection program;
(b) the master device receiving the inquiry command from the remote wireless device;
(c) the master device replying if the master device comprises the configuration inquiry/detection program or not to the remote wireless device;
(d) the remote wireless device determining whether the master device comprises the configuration inquiry/detection program; if yes, go to step (e), if not, go to step (i);
(e) the remote wireless device sending an inquiry command for asking version number of the configuration inquiry/detection program;
(f) the master device receiving the inquiry command for asking version number;
(g) the master device replying the version number to the remote wireless device;
(h) the remote wireless device determining whether the configuration inquiry/detection program requires update or not; if yes, go to step (i), if not, go to step (m);
(i) the remote wireless device sending codes of the configuration inquiry/detection program to the master device;
(j) the master device receiving the codes of the configuration inquiry/detection program from the remote wireless device;
(k) the master device executing the configuration inquiry/detection program;
(l) the configuration detection program sending the configuration settings of the master device to the remote wireless device;
(m) the remote wireless device receiving the configuration settings of the master device; and
(n) the remote wireless device storing the configuration settings of the master device to establish the configuration settings and the environment parameters acceptable for the remote wireless device and the master device both.

7. The method of claim 1 wherein the driver is installed by a software installation program, which comprises:
(a) the remote wireless device sending an inquiry command for checking whether the driver or the application program is installed in the master device and version number of the driver and the application program are stored in the master device or not;
(b) the master device receiving the inquiry command from the remote wireless device;
(c) the master device replying if the software installation program is installed in itself or not to the remote wireless device;
(d) the remote wireless device determining whether the master device is installed with the driver or the application program therein, if true, go to step (e), else go to step (f);
(e) the remote wireless device determining whether the version number of the driver and the application program require updates, if true, go to step (f), if not, go to step (j);
(f) the remote wireless device sending the codes of the driver or the application program to the master device;
(g) the master device receiving the codes of the driver or the application program from the remote wireless device;
(h) the master device executing the driver or the application program;
(i) the master device exchanging data and control massages with the remote wireless device by the driver installed by the software installation program; and
(j) the remote wireless device exchanging the data and the control massages with the master device.

8. The method of claim 1 further comprising the step, which is completed by a preference management program, that the master device sends a personalized control mode or preference data to the remote wireless device, the preference management program comprising:
(a) the remote wireless device sending an inquiry command for checking whether the master device is installed with the preference management program;
(b) the master device replying if the preference management program is installed in the master device to the remote wireless device;
(c) the remote wireless device determining whether the master device is installed with the preference management program, if yes, go to step (d), if not, go to step (e);
(d) the remote wireless device sending codes of the preference management program to the master device;
(e) the master device executing the preference management program;
(f) a set of preference values being generated according to the operation preferences of a user while operating the master device and the remote wireless device;
(g) the master device sending the preference values to the remote wireless device;
(h) the remote wireless device adjusting the preference values according to the operation preferences of the user continually and storing the preference values;
(i) the remote wireless device sending the adjusted preference values to the master device;
(j) the master device storing the preference values and adjusting the preference values according to the operation preferences of the user continually;
(k) the master device determining whether the preference values are changed or not, if yes, go to step (h), if not, go to step (j).

9. The method of claim 1 further comprising the step, which is completed by a database transferring program, that a database of the remote wireless device is transferred to the master device by the database transferring program for updating data of the remote wireless device and the master device simultaneously, the database transferring program comprising:
(a) a user setting that the database of the remote wireless device needs to be transferred;
(b) the remote wireless device backing up the environment parameters of the master device;
(c) the remote wireless device sending contents of the database of itself to the master device;
(d) the remote wireless device waiting for the transmission of the contents of the database of the remote wireless device from the master device;
(e) the remote wireless device checking whether the master device requires an off-line or not, if true, go to step (f), if not, go to step (d);
(f) the remote wireless device requesting the database and the environment variables of the master device need to be removed or not, if yes, go to step (g), if not, go to step (i);
(g) the remote wireless device sending a command for removing the database of the master device;
(h) the remote wireless device sending the backup environment parameters to the master device and restoring the previous environment of the master device;
(i) the remote wireless device being off-line with the master device.

10. An device for automatically installing software by wireless identification and transmission comprising:
a master device with a wireless transmission module for receiving or sending data according to a wireless communication protocol;
a remote wireless device with the wireless transmission module for communicating with the master device;
a database set within the remote wireless device and storing at least one wireless communication protocol, driver and application program, as well as functional information of the master device, installing information of the application program, personalized control mode and preference information data; and
a central processing unit within the remote wireless device for detecting the communication protocol with the master device, the installing information of the driver and the application program, transmission of the control commands, and fetching parameters of the master device.

11. The device of claim 10 wherein the master device is an information device with wireless communication function such as a desktop computer, a mainframe computer, a server, or a portable computer.

12. The device of claim 10 wherein the master device is a compact information device with wireless communication function such as a handheld computer, a PDA or a cellular phone.

13. The device of claim 10 wherein the remote wireless device is a computer peripheral with wireless communication function such as a printer, a monitor, a digital pad, a mouse, a scanner, a modem or a network terminal.

14. The device of claim 10 wherein the remote wireless device is a compact information device with wireless communication function such as a handheld computer, a PDA or a cellular phone.

15. The device of claim 10 wherein the database is a storage media such as an EEPROM, a flash memory, a floppy disk, a hard disk or a CD/DVD.
